(19) United States
(12) Patent Application Publication
(10) Pub. No.: US 2013/0192174 A1
(43) Pub. Date: Aug. 1, 2013

(54) Method for Fixing an Opening Device, Composite Film and Tubular Bag Having an Opening Device

(71) Applicants: Joerg P. Weltert, Wallisellen (CH); Dirk Ekenhorst, Osnabruck (DE)

(72) Inventors: Joerg P. Weltert, Wallisellen (CH); Dirk Ekenhorst, Osnabruck (DE)

(73) Assignee: Robert Bosch GmbH, Stuttgart (DE)

(21) Appl. No.: 13/696,534

(22) PCT Filed: May 26, 2011
(86) PCT No.: PCT/EP2011/058623

§ 371 Date: Mar. 15, 2013

(30) Foreign Application Priority Data
May 27, 2010 (DE) 10 2010 029 356.3

(51) Int. Cl. B23K 20/10; B32B 3/26

(52) U.S. Cl. CPC B23K 20/10; B32B 3/266
USPC 53/476; 383/42; 428/138

(57) ABSTRACT

A method is presented for fixing an opening device to a packaging container made of a composite film. The packaging container is a tubular bag, and the composite film includes a barrier layer and a further layer. The barrier layer is part of the composite film and the further layer includes a recess in the region of the opening device. The opening device is a connecting flange configured to be fixed to the composite film and includes a separating mechanism configured to sever the barrier layer to form a passage in the composite film. The further layer is arranged on the side facing away from the connecting flange.

### PRIOR ART

The invention relates to a method for fixing an opening device according to the preamble of the two independent claims. The invention also relates to a composite sheet material and to a packaging container which is designed as a tubular bag and has an opening device.

Such a method for fixing an opening device is known from U.S. Pat. No. 5,482,176. The packaging container here consists of a multilayered material which comprises a cardboard which is coated on the inside and outside. The outer coating of the cardboard contains an aperture in the region of the opening device. Furthermore, the opening device is connected to the outer coating of the cardboard by means of an additional adhesive layer. The task of connecting the packaging container to the opening device thus involves relative high outlay.

Furthermore, WO 2007/149231 A2 discloses a method in which a hole is punched out of the wall of a laminated sheet material, which comprises a plurality of layers and from which the packaging container is formed, this hole being covered over from the inside by an additional material layer, which is in the form of a packaging-material strip and serves as a barrier layer. From the other side of the laminated sheet material, an opening device is made to cover over the punched-out hole and is connected to the packaging-material strip via an annular region. The opening device has a cutting device in the form of cutting teeth which, in order to open the packaging container, perforates or severs the additional material layer in order thus to allow, for example, a liquid to be poured out of the packaging container designed as a tubular bag.

Such packaging containers in the form of tubular bags are produced in so-called tubular-bag machines. In this case, the holes for the opening devices are severed from, or punched out of, an endless packaging-material web at a separate entry station. The material portions which form the subsequent barrier layers are then sealed onto the packaging-material web from the subsequent inside of the packaging container.

The necessary operation of punching the packaging-material web and then that of sealing on the barrier layers means that the known method involves relative high outlay, since an additional punching-out device and a sealing device are required. In particular, problems may arise if, in the event of a punching device and/or the sealing device malfunctioning, the entire production and/or filling process of the tubular-bag machine has to be interrupted for a relatively long period of time. Furthermore, it may also be considered to be a disadvantage that, as a result of the hole being punched out and then reclosed by the material layer of the packaging-material strip, the original barrier layers had to be severed or destroyed. This constitutes a potential weak point insofar as production of the original barrier protection function requires a high-quality packaging-material strip (in respect of material and thickness) and a high level of processing reliability.

### DISCLOSURE OF THE INVENTION

Proceeding from the prior art presented, it is an object of the invention to develop a method for fixing an opening device according to the preambles of the two independent claims such that the opening devices can be fixed particularly straightforwardly, without additional substances being used. At the same time, it is intended both to reduce the equipment-related outlay and for it to be possible to avoid disruption to operation with corresponding production stoppages and downtimes during production of packaging containers. A further intention is to ensure the highest possible barrier protection action and level of processing reliability. This object is achieved in the case of a method for fixing an opening device having the features of the two independent claims. The invention here is based on the concept of it being possible, by using a specifically pre-treated packaging-material web or a specifically produced laminated sheet material, which contains apertures in the region of the subsequent opening devices, to dispense with the use of additional auxiliary substances for connecting the opening devices to the composite sheet materials.

Advantageous developments of the method according to the invention for fitting an opening device are specified in the dependent claims. The invention covers all combinations of at least two features disclosed in the claims, the description and/or the figures.

It is particularly preferably provided here that the aperture is formed by a punching or laser process, both of which are relatively straightforward to realize in production terms and operate reliably.

The invention also comprises a composite sheet material for use of a method according to the invention. It is provided here that the composite sheet material is produced by connecting a first layer structure to a second layer structure, wherein the second sheet-material layer structure has the at least one further layer, and wherein the aperture is created in the at least one further layer of the second layer structure prior to it being connected to the second layer structure. A composite sheet material created from two layer structures by such a method can be produced relatively straightforwardly, since the aperture in the second layer structure can be produced relatively straightforwardly by means of known production techniques.

Further advantages, features and details of the invention can be gathered from the following description of preferred exemplary embodiments and with reference to the drawing, in which:

FIG. 1 shows a simplified side view of a contents-filled tubular bag having an opening device,

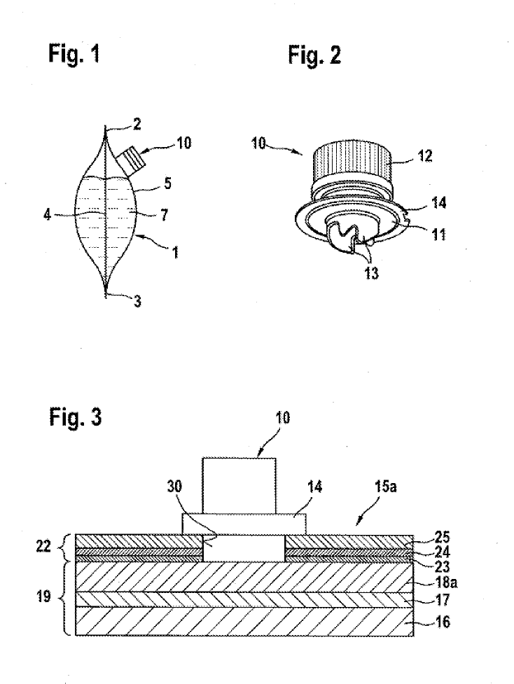

FIG. 2 shows a perspective illustration of an opening device,

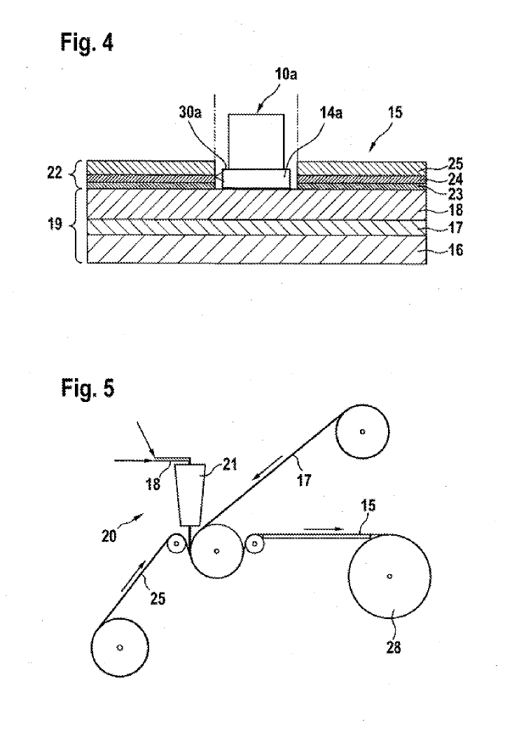

FIGS. 3 and 4 each show sections through a composite sheet material with opening devices arranged on the composite sheet material,

FIG. 5 shows a simplified illustration in order to explain the method for producing a composite sheet material for producing tubular bags according to FIG. 1,

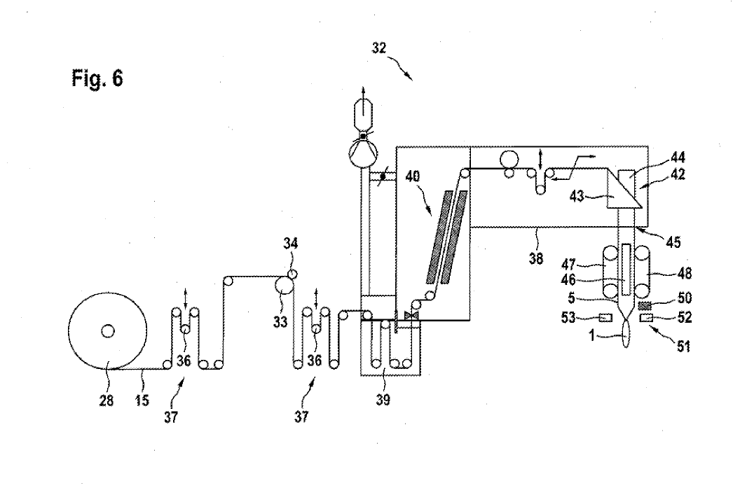

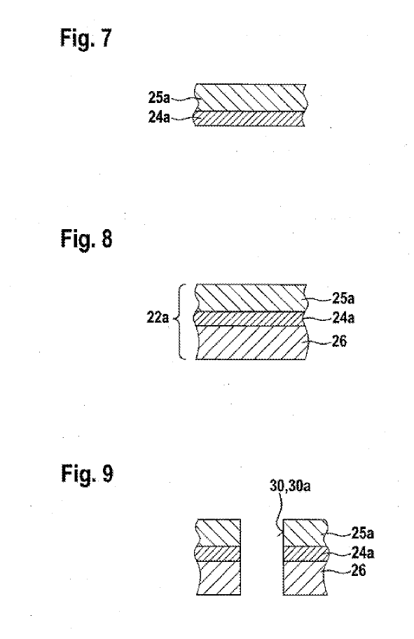

FIG. 6 shows a simplified illustration of a packaging machine for producing contents-filled tubular bags, FIGS. 7 to 11 show a simplified illustration in order to explain the method for producing a first alternative composite sheet material, and

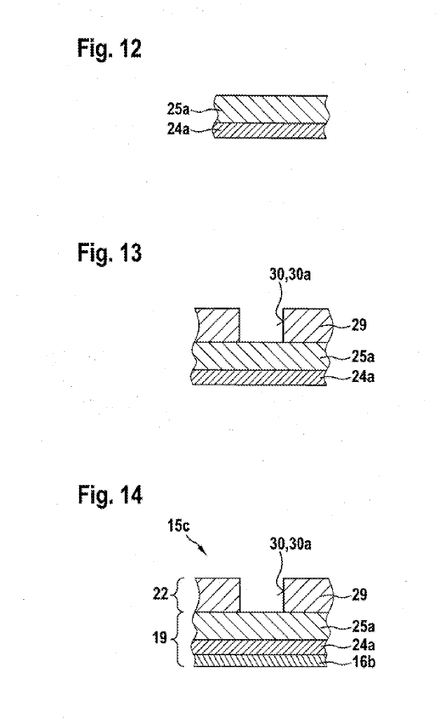

FIGS. 12 to 14 show a simplified illustration in order to explain the method for producing a second alternative composite sheet material.

FIG. 1 illustrates, in simplified form a packaging container which is designed as a tubular bag 1. The tubular bag 1 has an upper transverse seam 2, a lower transverse seam 3 and at least one longitudinal seam 4. It may also be provided that, in the base region and/or in the head region of the tubular bag 1, the latter is designed with a folded base closure and/or a folded head closure, in order to make it possible, for example, for the tubular bag 1 to stand up or have a certain visual appearance.

Preferably in the upper region of the tubular bag 1, but beneath the upper transverse seam 2, an opening device 10 is arranged on the outer wall 5 of the tubular bag 1. As can best be seen with reference to FIG. 2, the opening device 10, which preferably consists of plastics material and is produced by injection molding, has a basic body 11, which is connected to a removable lid closure 12. The screw-action lid closure 12 interacts with cutting teeth 13 which, upon rotation of the lid closure 12, pass into operative connection with the outer wall 5 of the tubular bag 1 in order to sever the latter and/or to form a through-passage, and thus to allow removal of product 7, e.g. a liquid product 7, such as milk, fruit juices or the like, located in the tubular bag 1. The basic body 11 also has an encircling connection flange 14 which serves for fixing the opening device 10 to the tubular bag 1.

The tubular bag 1 consists of a composite sheet material made up of a multiplicity of flexible layers, in particular a laminated composite sheet material 15, 15a, and according to FIGS. 3 and 4, by way of example and without being restricted in any way, it has a structure with, in the first instance, an LDPE sealing layer 16 (LDPE=low density polyethylene) on the inside of the tubular bag 1. The LDPE sealing layer 16 is followed by an aluminum layer 17. The aluminum layer 17 is followed by an MDPE layer 18 (MDPE=medium density polyethylene), which is connected to the aluminum layer 17 by extrusion (FIG. 4). In the laminated composite sheet material 15a according to FIG. 3, an adhesive layer 18a is used instead of the MDPE layer 18.

The first layer structure 19, which comprises the LDPE sealing layer 16, the aluminum layer 17 and the MDPE layer 18 or the adhesive layer 18a and acts as a barrier layer or barrier-layer composite, is connected to a second layer structure 22 by means of a production device 20, which is illustrated in simplified form in FIG. 5 and comprises a coextrusion device 21. The second layer structure 22 comprises a primer layer 23, a pressure-exerting layer 24 and a carrier layer 25. The second layer structure 22 is connected to the first sheet-material layer structure 19, by means of the production device 20 illustrated in FIG. 5, to form the laminated composite sheet material 15 or 15a and is wound up to form a packaging-material roll 28.

It is essential to the invention that the second layer structure 22 has an aperture 30, 30a in each case in the regions in which the opening devices 10 are arranged during production of the tubular bags 1. The apertures 30, 30a here are created and/or formed in the second layer structure 22 already during production of the second layer structure 22, using an appropriate production device, in particular using a punching device (not illustrated) or a laser-beam-cutting device. In particular, the essential factor is that the apertures 30 are formed at least in the region of the carrier layer 25, since the carrier layer 25 consists of OPP (oriented polypropylene), PET or a material which can be subjected to similar mechanical loading, and/or is of such a strength/toughness that the cutting teeth 13 of the opening device 10 cannot (usually) sever it.

The packaging-material roll 28 with the rolled-up laminated composite sheet material 15, 15a thus already has the apertures 30 for the opening devices 10, wherein the essential factor is that the apertures 30 are arranged on the laminated composite sheet material 15, 15a preferably at certain, uniform intervals corresponding to the format of the tubular bags 1 produced from the laminated composite sheet material 15, 15a. This allows waste-free processing of the packaging-material roll 28.

In the case of that exemplary embodiment of the invention which is illustrated in FIG. 3, the aperture 30 has a size which is smaller than the size or the diameter of the connection flange 14 of the opening device 10. In the case of this embodiment, the connection flange 14 has its underside connected to the carrier layer 25, which forms the subsequent outer wall 5 of the tubular bag 1. Connection takes place preferably by means of an ultrasonic welding device (not illustrated) or of a heat-sealing device. This device connects the connection flange 14 of the opening device 10 to an in particular radially encircling connecting seam such that the connection flange 14 is sealed to the carrier layer 25. It can also be seen with reference to FIG. 3 that the opening device 10 or the basic body 11 or the cutting teeth 13 is or are not yet in operative connection with the first sheet-material layer structure 19. This takes place only when the tubular bags 1 are opened in order for the product 7 to be removed.

In the case of that exemplary embodiment of the invention which is illustrated in FIG. 4, the aperture 30a has a size or a diameter which is larger than the size of the connection flange 14 of the opening device 10a. In the case of this embodiment, the opening device 10a has its connection flange 14a applied to the MDPE layer 18 and connected thereto, preferably by an ultrasonic welding device (not illustrated).

FIG. 6 illustrates, in simplified form, a packaging installation 32 for producing tubular bags 1 from a packaging-material roll 28 and for filling the tubular bags 1. The packing installation 32 has transporting rollers 33, 34, by means of which the packaging-material roll 28 is unrolled. It is also possible to see a plurality of compensating devices 37 which have compensating rollers 36 and which allow for compensation between cyclic advancement and continuous advancement of the material of the packaging-material roll 28 in different regions of the packaging machine 32. Following unrolling, the laminated composite sheet material 15 passes into the region of a machine housing 38 of the packaging machine 32, wherein a sterile atmosphere prevails, or sterile conditions prevail, within the machine housing 38. The machine housing 38 contains a sterilizing bath 39, in which is located, for example, liquid hydrogen peroxide in order to sterilize the laminated composite sheet material 15. The laminated composite sheet material 15 is then dried by means of a drying device 40 and fed to a vertical tubular-bag machine 42.

The tubular-bag machine 42 has a forming shoulder 43 and a forming and filling tube 44 which is coupled to a supply store (not illustrated) for the product 7 which is to be introduced. The forming and filling tube 44 passes through the machine housing 38 in the region of an outlet 45. Non-sterile conditions prevail in the region of the packaging machine 32 from the region of the outlet 45 onward. In the lower region of the forming and filling tube 44, it is further possible to see a longitudinal-seam-sealing device 46 and two vacuum-assisted, cyclically operating withdrawal belts 47, 48. It is also possible to see an application device 50 for fitting the opening devices 10 on the outer wall 5 of the tubular bags 1. The application device 50, which is not illustrated in any more detail, essentially comprises the aforementioned ultrasonic welding device and is preferably coupled to a supply magazine for the opening devices 10. The essential factor here is that the application device 50 is still arranged in the region of the forming and filling tube 44, and therefore, when the opening devices 10 are fitted on the outer wall 5 of the subsequent tubular bags 1, the forming and filling tube 44 forms an abutment for the opening device 10, in order to allow for the required contact pressure of the connection flange 14 on the outer wall 5. It is also essential for the application device 50 to be located in the non-sterile region. This allows direct access in the event of (any possible) disruption to operation of the application device 50, without the sterility of the upstream region of the packaging installation 32 being affected. Furthermore, there is no need for the opening devices 10 to have to be sterilized.

A transverse-seam-sealing device 51 is arranged beneath the forming and filling tube 44, this device having two transverse-seam-sealing jaws 52 and 53, which can be displaced in relation to one another, and severing blades (not illustrated) for severing a respective tubular bag 1 from the flexible packaging-material tube. The essential factor in the process for producing the tubular bags 1 is that the application device 50 aligns the opening devices 10 with the apertures 30, 30a such that they cover the apertures 30, 30a in alignment therewith.

FIGS. 7 to 11 show the process for producing a laminated composite sheet material 15b, which can likewise be used as an alternative to the laminated composite sheet materials 15, 15a. In this case, in a manner corresponding to FIG. 7, in the first instance the carrier layer 25a, which consists of PET or OPP, has its rear side printed with the pressure-exerting layer 24a, which has a pressure-exerting pattern. Then, in a manner corresponding to FIG. 8, on the side which is located opposite the carrier layer 25a the pressure-exerting layer 24a is connected to a layer 26 which can be subjected to mechanical loading, for example made of polyamide (PA), by adhesive lamination or extrusion lamination. The carrier layer 25a, the pressure exerting layer 24a and layer 26 thus form the second layer structure 22a.

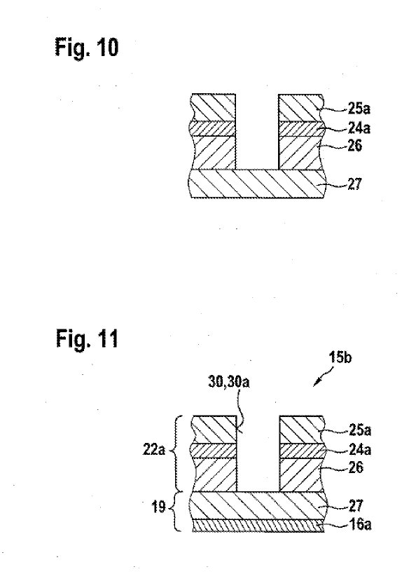

Then, in a manner corresponding to FIG. 9, the apertures 30, 30a are formed in the second layer structure 22a. The second layer structure 22a produced in this way is then connected, in a manner corresponding to FIG. 10, to a prefabricated intermediate layer 27. This takes place by extrusion lamination. The intermediate layer 27 here comprises, for example, polyester, polyamide, polypropylene with our without barrier coatings, films with one or more layers, produced by blow molding or casting, or else an aluminum foil with a thickness between 5 μm and 15 μm. In a final step, in a manner corresponding to FIG. 11, in a further extrusion process, the intermediate layer 27 is provided, on the side which is located opposite the second layer structure 22a, with the sealing layer 16a, which is necessary for forming the tubular bags 1 and usually consists of polyethylene. It is possible here, by means of coextrusion, for the sealing layer 16a to be coated with different densities of polyethylene in order to control the adhesion and sealing properties.

In the case of the process for producing the laminated composite sheet material 15c which is illustrated in FIGS. 12 to 14, in the first instance, in a first step according to FIG. 12, the carrier layer 25a, which consists of PET or OPP, has its rear side printed with the pressure-exerting layer 24a, which has a pressure-exerting pattern. Then, according to FIG. 13, the carrier layer 25a, on the side which is directed away from the pressure-exerting layer 24a, is connected, by adhesive lamination or extrusion lamination, to a prefabricated, blow-molded and thus relatively high-strength layer 29 comprising one or more sublayers. Prefabrication here also comprises the operation of forming the apertures 30, 30a. By virtue of using suitable plastics materials, for example EVOH or PVDC inter alia, the layer 29 may have the barrier function which is necessary for product-protection purposes. In a third step, which is illustrated in FIG. 14, the pressure-exerting layer 24a is provided with the sealing layer 16b. This takes place preferably by means of cast-extrusion coating. In this case, slot dies are used for producing the sealing layer 16b. As a result, the polymer melt, shortly after leaving the dies, comes into contact with chill rolls and the carrier material (carrier layer 25a and pressure-exerting layer 24a), which immediately freezes the molecular chain structure and keeps it short. This provides for very good cutability, which facilitates opening of the tubular bag 1 by the opening device 10, 10a. Instead of the cast extrusion process described, it is also possible for the carrier material (carrier layer 25a and pressure-exerting layer 24a) to be connected to the layer 29 by adhesive lamination.

1. A method for fixing an opening device on a packaging container, wherein a material of the packaging container comprises a composite sheet material with at least one barrier layer, wherein the opening device has a connection flange configured to be fixed to the composite sheet material, wherein the opening device has a severing mechanism configured to sever the at least one barrier layer to form a through-passage in the composite sheet material, wherein the composite sheet material, on a side which is directed toward the connection flange, has at least one further layer, wherein the at least one further layer, on the side which is directed toward the opening device, has at least a first carrier layer, and wherein the at least one further layer of the composite sheet material has an aperture in a region of the opening device, comprising:
producing the packaging container from the composite sheet material such that the packaging container is configured as a tubular bag, and such that the aperture is smaller than the connection flange; and
connecting the connection flange to the first carrier layer by heat sealing or ultrasonic welding, without using any additional adhesive layer.

2. A method for fixing an opening device on a packaging container, wherein a material of the packaging container comprises a composite sheet material with at least one barrier layer, wherein the opening device has a connection flange configured to be fixed to the composite sheet material, wherein the opening device has a severing mechanism configured to sever at least one barrier layer to form a through-passage in the composite sheet material, wherein the composite sheet material, on a side which is directed toward the connection flange, has at least one further layer, wherein the at least one further layer, on a side which is directed toward the opening device, has at least a first carrier layer, and wherein the at least one further layer of the composite sheet material has an aperture in a region of the opening device, comprising:
producing the packaging container from the composite sheet material such that the packaging container is configured as a tubular bag, and such that the aperture is larger than the connection flange; and
connecting the connection flange to the at least one barrier layer of a first layer structure.

3. The method as claimed in claim 2, wherein the connection flange is connected to the composite sheet material by ultrasonic welding or heat sealing.

4. The method as claimed in claim 1, wherein the aperture is formed by a punching or laser process.

5. The method as claimed in claim 1, further comprising:
fixing the opening device with an application device in a region of a forming and filling tube of a tubular-bag machine.

6. The method as claimed in claim 5, wherein the application device is arranged in a non-sterile region of the tubular-bag machine.

7. A composite sheet material for use in a method for fixing an opening device on a packaging container comprising:
a first layer structure connected to a second layer structure, wherein the second layer structure has at least one further layer; and
an aperture formed in the at least one further layer before the at least one further layer is connected to the second layer structure.

8. The composite sheet material as claimed in claim 7, wherein the composite sheet material is produced with extrusion.

9. The composite sheet material as claimed in claim 7, wherein the first layer structure includes at least one barrier layer that is an aluminum layer.

10. The composite sheet material as claimed in claim 7, wherein the second sheet-material layer structure has a layer configured to be subjected to pronounced mechanical loading and made of polyamide.

11. The composite sheet material as claimed in claim 7, wherein the second layer structure has a layer configured to be subjected to pronounced mechanical loading and produced by blow molding.

12. The composite sheet material as claimed in claim 11, wherein:
the layer includes one or more sublayers; and
the layer is connected, via adhesive bonding or extrusion, to a pressure-exerting layer which is connected to a carrier layer.

13. The composite sheet material as claimed in claim 11, wherein the layer is configured to act as a barrier and contains ethylene vinyl alcohol polyvinylidene chloride.

14. A packaging container comprising:
a composite sheet material configured as a tubular bag;
an opening device fixed to the composite sheet material by:
producing the packaging container such that an aperture is smaller than a connection flange of the opening device; and
connecting the connection flange to a first carrier layer of the composite sheet material by heat sealing or ultrasonic welding, without using any additional adhesive layer.
